(19) United States
(12) Patent Application Publication
(10) Pub. No.: US 2007/0279480 A1
(43) Pub. Date: Dec. 6, 2007

(54) OPTICAL DISK APPARATUS

(75) Inventor: Kenji Asano, Gifu-city (JP)

Correspondence Address: DITTHAVONG MORI & STEINER, P.C., 918 Prince St., Alexandria, VA, 22314, US

(73) Assignees: Sanyo Electric Co., Ltd., Moriguchi-shi (JP); Sanyo Optec Design Co., Ltd., Tokyo (JP)

(21) Appl. No.: 11/758,235

(22) Filed: Jun. 5, 2007

(30) Foreign Application Priority Data
Jun. 5, 2006 (JP) 2006-155594

(51) Int. Cl. B41J 2/455

(52) U.S. Cl. 347/233

(57) ABSTRACT

Two objective lenses are attached to a common holder. The holder is driven by an objective lens actuator, which integrally drives the two objective lenses. At this point, the objective lens (first objective lens) having a smaller diameter is arranged on a disk inner circumference side. In labeling, a reference pattern located at an inner circumference position is irradiated with a laser beam through the inner circumference-side first objective lens to obtain a gain which is used to finely move an objective lens actuator in a disk radial direction. The disk is irradiated with the laser beam through the second objective lens to generate an image in a disk surface while the objective lens actuator is driven with the gain.

This application claims priority under 35 U.S.C. Section 119 of Japanese Patent Application No. 2006-155594 filed Jun. 5, 2006.

### BACKGROUND OF THE INVENTION

1. Field of the Invention

The present invention relates to an optical disk apparatus in which labeling is performed to an optical disk using a laser beam outgoing from an optical pickup, particularly to the optical disk apparatus provided with a compatible optical pickup including plural objective lenses.

2. Description of the Related Art

Currently, there are known various techniques as an optical disk labeling technique. Among others, the optical disk labeling technique with a laser beam emitted from an optical pickup is used as the labeling technique for CD (Compact Disc) and DVD (Digital Versatile disc).

In the labeling technique, the optical disk is loaded on a disk drive while a right surface in recording/reproduction is reversed. When a user inputs a desired image, a disk surface labeling driver is driven to print the image on a disk surface. At this point, the disk is rotated at a predetermined speed. The laser beam is fed in a disk radial direction while intensity-modulated according to the image. The laser beam feed in the disk radial direction is performed by a coarse feed in which an optical pickup body is moved and a fine feed in which an objective lens is finely moved.

In this case, a gain (drive signal value to drive amount) in driving the objective lens in the disk radial direction is determined based on a reference pattern arranged at an innermost circumference position or an outermost circumference position of the disk. The objective lens is finely moved in the disk radial direction based on the gain, and thereby a beam irradiation position is finely controlled during the labeling.

For example, the reference pattern is formed in a sawtooth shape which is linearly inclined in the disk radial direction. In obtaining the gain, the position where the reference pattern is arranged is irradiated with a beam spot while the disk is rotated at a predetermined speed. A beam spot scanning position (radial position) is detected in the disk radial direction from a duty cycle of a reflectance signal which is detected in scanning the reference pattern with the beam spot. Several samples of the radial position are obtained within a reference pattern arrangement range while the beam spot is changed in the disk radial direction, and the obtained radial position and the drive signal value applied to an objective lens actuator at that time are stored in a table as needed. The radial position and drive signal of each sample stored in the table are set to a coordinate value, and a straight line which is best matched with all the coordinate values is determined. A gradient of the straight line is obtained as the gain of the objective lens actuator when the beam spot is driven in the disk radial direction.

Recently, in addition to CD and DVD, an optical disk (hereinafter referred to as “next-generation DVD”) in which a blue laser beam having a wavelength of about 400 nm is used as a recording/reproduction laser beam is standardized, and the next-generation DVD is developed for commercialization. An optical pickup compatible with both the already-existing CD and DVD and the next-generation DVD is required when the next-generation DVD is commercialized. One of the possible ways is to mount both a CD/DVD objective lens and a next-generation DVD objective lens on the optical pickup.

In the case where the two objective lenses are used, the objective lenses can be arranged inline in a direction orthogonal to the disk radial direction. However, when the two objective lenses are arranged while one of the objective lenses is moved on a disk diameter, the other objective lens is moved along the disk diameter at the position which is separated away from the disk diameter by a predetermined distance. In this case, a track direction which is projected onto a photodetector through the objective lens shifted from the disk diameter is changed as the objective lens is moved from an inner circumference position to an outer circumference position of the disk.

The above problem can be solved by arranging the two objective lenses in line in the disk radial direction. However, when one of the objective lenses located on the disk outer circumference side is moved to the innermost circumference position of the disk, the other objective lens on the disk inner circumference side is located on the disk inner circumference side of one of the objective lenses. Therefore, in the case where the two objective lenses are arranged in line in the disk radial direction, there is generated a problem that clearance is hardly ensured between a turntable and the objective lens on the disk inner circumference side.

In Blu-ray Disc (registered trademark, hereinafter referred to as “Blu-ray disk”) which is developed for commercialization as one of the next-generation DVDs, the innermost circumference position of a data area is shifted to the disk inner circumference side compared with the already-existing CD and DVD. Therefore, in order to deal with the clearance problem, it is advantageous that the Blu-ray disk objective lens is arranged on the disk inner circumference side.

Generally a lens diameter of the next-generation DVD objective lens can be formed smaller than that of the CD/DVD objective lens. Accordingly, when the next-generation DVD objective lens having the smaller lens diameter is arranged on the disk inner circumference side in consideration of this point, as is clear from comparison of FIGS. 12A and 12B, the clearance problem can smoothly be dealt with.

However, in the currently commercialized CD and DVD, the reference pattern used in the labeling technique is arranged at the disk innermost circumference position which is located on the disk inner circumference side of the innermost circumference position of the data area. Therefore, in order to providing for the labeling technique, it is desirable that the CD/DVD objective lens used in the labeling be arranged on the disk inner circumference side rather than the next-generation DVD objective lens.

The reference pattern arrangement position in CD and DVD is located at the same position as the innermost circumference position of the data area in the Blu-ray disk.

### SUMMARY OF THE INVENTION

In view of the foregoing, an object of the invention is to provide an optical disk apparatus which smoothly performs the labeling to the disk while suppressing the clearance problem between the inner circumference-side objective lens and the turntable, when the two objective lenses are arranged in line in the disk radial direction.

In the invention, two objective lenses are attached to a common holder. The holder is driven by an objective lens actuator, which integrally drives the two objective lenses.

In the labeling, the reference pattern located at the disk innermost circumference position is irradiated with the laser beam through the first objective lens arranged on the inner circumference side. That is, the reference pattern is scanned by the laser beam through the first objective lens, and the gain is obtained in order to finely move the first objective lens in the disk radial direction. The obtained gain is also used to drive the objective lens (second objective lens) on the disk outer circumference side. That is, in the invention, because the two objective lenses are integrally driven with a holder, the gain for the first objective lens which is obtained based on the reference pattern can also be used as the gain for the second objective lens which is integrally driven along with the first objective lens.

In the invention, after the gain for the first objective lens is obtained, the first and second objective lenses are integrally driven using the gain, and the disk is irradiated with the laser beam through the second objective lens. This enables the image to be labeled on the disk.

Thus, according to the invention, because the reference pattern is irradiated with the laser beam through the first objective lens located on the inner circumference side in obtaining the gain, it is not necessary that the first objective lens drive position be located on the disk inner circumference side of the reference pattern. Therefore, the clearance can be ensured between the first objective lens and the turntable. The obtained gain is directly used as the gain for the second objective lens, so that the smooth labeling operation can be realized by irradiating the disk with the laser beam from the second objective lens to perform the labeling of the image.

Additionally, in the configuration of the invention, the objective lens (first objective lens) having the smaller lens diameter may be arranged on the disk inner circumference side. According to this, as can be seen from FIG. 12, the clearance can be increased between the turntable and the disk inner circumference-side objective lens.

In the case where the invention is applied to the CD/DVD/next-generation DVD compatible pickup, the first objective lens corresponds to the next-generation DVD objective lens and the second objective lens corresponds to the CD/DVD objective lens. At this point, in the case where the next-generation DVD is the Blu-ray disk, a working distance of the next-generation DVD objective lens to the disk surface becomes considerably small. On the other hand, in the already-existing DVD, because the reference pattern is arranged at the back of a substrate having a thickness of 0.6 mm, the next-generation DVD objective lens possibly collides with the surface of the substrate when the reference pattern is read using the next-generation DVD objective lens. The invention also includes means for solving the problem.

The main feature of the invention is described as follows.

An optical disk apparatus according to an aspect of the invention includes a first light source which emits a laser beam having a first wavelength; a second light source which emits a laser beam having a second wavelength; a first objective lens which converges the laser beam having the first wavelength; a second objective lens which converges the laser beam having the second wavelength; a holder which integrally holds the first objective lens and the second objective lens; an objective lens actuator which drives the holder; a pickup actuator which drives an optical pickup in a disk radial direction, the optical pickup including the first light source, the second light source, the first objective lens, the second objective lens, the holder, and the objective lens actuator; a spindle motor which rotates a disk; and an image generation circuit which generates an image in a disk surface by driving and controlling the first light source, the second light source, the objective lens actuator, the pickup actuator, and the spindle motor. At this point, the first objective lens and the second objective lens are arranged in line on a disk diameter, the first objective lens is arranged on a disk inner circumference side of the second objective lens. The image generation circuit irradiates a reference pattern with the laser beam having the first wavelength while rotating the disk which is of an image generation target, the reference pattern being formed at an inner circumference position of the disk, the image generation circuit obtains a gain when the objective lens actuator is driven in the disk radial direction, and the image generation circuit irradiates the disk of the image generation target with the laser beam having the second wavelength to generate the image in the disk surface while driving the objective lens actuator with the obtained gain.

As used herein, “image generation circuit” is mainly implemented by a controller 10 and a servo circuit 16.

### BRIEF DESCRIPTION OF THE DRAWINGS

The foregoing and other objects and novel features of the invention will become more fully obvious from the following description of the embodiments in connection with the accompanying drawings.

FIGS. 1A and 1B show an optical system of an optical pickup according to a first example;

FIG. 2 shows an area format of a compact disk;

FIG. 3 shows a configuration of an optical disk apparatus of the first example;

FIGS. 4A and 4B are views explaining a process of obtaining a radial position of a beam spot of the first example;

FIG. 5 shows a processing flowchart in a labeling operation of the first example;

FIG. 6 is a view explaining a process of obtaining a gain of the first example;

FIGS. 7A, 7B, and 7C are views explaining a beam spot size of the first example;

FIGS. 8A and 8B show an optical system of an optical pickup according to a second example;

FIGS. 9A and 9B are views explaining a beam spot size of the second example;

FIGS. 10A and 10B are views explaining a process of right-sizing a beam spot of the second example;

FIG. 11 shows a processing flowchart in a labeling operation of the second example; and

FIGS. 12A and 12B are views explaining a problem of a conventional technique.

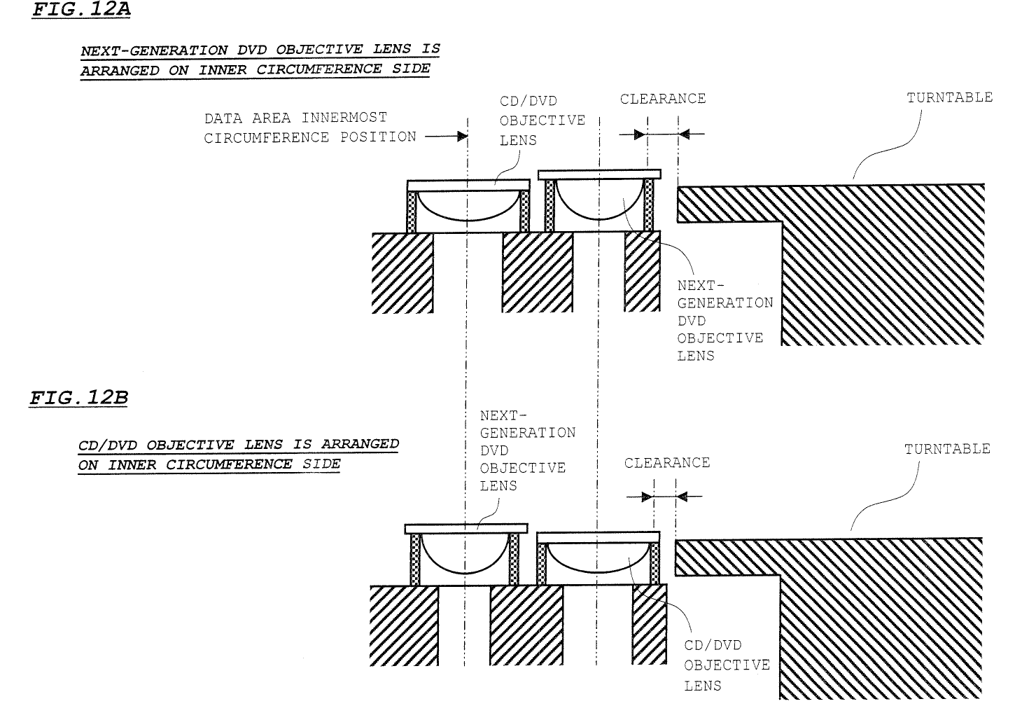

However, the drawings are illustrated only by way of example, and the scope of the invention is not limited to the drawings.

### DESCRIPTION OF THE PREFERRED EMBODIMENTS

Preferred embodiments of the invention will be described below with reference to the drawings.

### FIRST EXAMPLE

In this example, the invention is applied to an optical disk apparatus in which the recording and reproduction are performed to the next-generation DVD and CD.

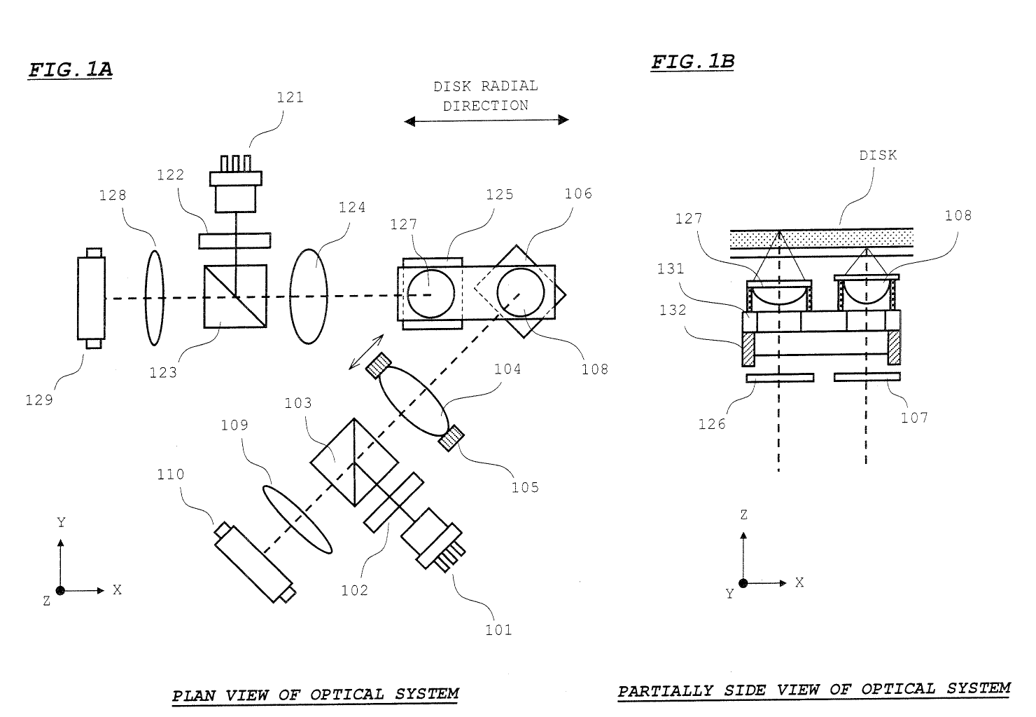

FIGS. 1A and 1B show an optical system of an optical pickup according to an example. FIG. 1A is a plan view of the optical system and FIG. 1B is a side view showing a neighborhood of an objective lens actuator. The optical system is divided into a next-generation DVD optical system and a CD optical system.

The next-generation DVD optical system includes a semiconductor laser 101, a diffraction grating 102, a polarization beam splitter 103, a collimator lens 104, a lens actuator 105, a rising mirror 106, a λ/4 plate 107, a first objective lens 108, an anamorphic lens 109, and a photodetector 110.

The semiconductor laser 101 emits a blue laser beam having a wavelength of about 400 nm. The diffraction grating 102 divides the laser beam emitted from the semiconductor laser 101 into three beams. The polarization beam splitter 103 reflects the laser beam incident from the side of the diffraction grating 102. The collimator lens 104 converts the laser beam reflected from the polarization beam splitter 103 into parallel light. The lens actuator 105 drives the collimator lens 104 in an optical axis direction of the laser beam.

The collimator lens 104 and the lens actuator 105 functions as aberration correction means. That is, the collimator lens 104 is driven by the lens actuator 105 at the position where a reproduction RF signal becomes the optimum. The lens actuator 105 drives the collimator lens 104 according to a control signal from a servo circuit (described later).

The rising mirror 106 reflects the laser beam incident through the collimator lens 104 toward the first objective lens 108. The λ/4 plate 107 converts the laser beam reflected from the reflecting mirror 106 into circularly polarized light, and the λ/4 plate 107 converts the light reflected from the disk into linearly polarized light which is orthogonal to a polarization direction when the light is incident to the disk. Therefore, the laser beam reflected from the disk is guided to the photodetector 110 through the polarization beam splitter 103.

The first objective lens 108 is designed such that the laser beam having the blue wavelength can properly be converged onto a signal surface of the next-generation DVD. That is, in the case where the target disk is a Blu-ray disk, the first objective lens 108 is designed such that the laser beam having the blue wavelength can properly be converged onto the signal surface through a substrate having a thickness of 0.1 mm. In the case where the target disk is HDDVD (High Definition Digital Versatile Disc), the first objective lens 108 is designed such that the laser beam having the blue wavelength can properly be converged onto the signal surface through a substrate having a thickness of 0.6 mm.

The anamorphic lens 109 converges the laser beam reflected from the disk onto the photodetector 110. The anamorphic lens 109 includes a collective lens and a cylindrical lens to introduce astigmatism into the light reflected from the disk.

The photodetector 110 has a sensor pattern. The sensor pattern is used to derive a reproduction RF signal, a focus error signal, and a tracking error signal from an intensity distribution of the received laser beam. In this example, an astigmatism method is adopted as a technique of generating the focus error signal, and a DPP (Differential Push Pull) method is adopted as a technique of generating the tracking error signal. The photodetector 110 has the sensor pattern for deriving the focus error signal and the tracking error signal according to the techniques.

The CD optical system includes a semiconductor laser 121, a diffraction grating 122, a polarization beam splitter 123, a collimator lens 124, a rising mirror 125, a λ/4 plate 126, a second objective lens 127, an anamorphic lens 128, and a photodetector 129.

The semiconductor laser 121 emits an infrared laser beam having a wavelength of about 780 nm. The diffraction grating 122 divides the laser beam emitted from the semiconductor laser 121 into three beams. The polarization beam splitter 123 reflects the laser beam incident from the side of the diffraction grating 122. The collimator lens 124 converts the laser beam reflected from the polarization beam splitter 123 into parallel light. The rising mirror 125 reflects the laser beam incident through the collimator lens 124 toward the second objective lens 127. The λ/4 plate 126 converts the laser beam reflected from the reflecting mirror 125 into circularly polarized light, and the λ/4 plate 126 converts the light reflected from the disk into linearly polarized light which is orthogonal to a polarization direction when the light is incident to the disk. Therefore, the laser beam reflected from the disk is guided to the photodetector 129 through the polarization beam splitter 123.

The second objective lens 127 is designed such that the laser beam having the infrared wavelength can properly be converged onto the signal surface of CD. That is, the second objective lens 127 is designed such that the laser beam having the infrared wavelength can properly be converged onto the signal surface through a substrate having a thickness of 1.2 mm.

The anamorphic lens 128 converges the laser beam reflected from the disk onto the photodetector 129. The anamorphic lens 128 includes a collective lens and a cylindrical lens to introduce the astigmatism into the light reflected from the disk.

The photodetector 129 has a sensor pattern. The sensor pattern is used to derive the reproduction RF signal, the focus error signal, and the tracking error signal from the intensity distribution of the received laser beam. In this example, as described above, the astigmatism method is adopted as the technique of generating the focus error signal, and the DPP (Differential Push Pull) method is adopted as the technique of generating the tracking error signal. The photodetector 129 has the sensor pattern for deriving the focus error signal and the tracking error signal according to the techniques.

The first objective lens 108 and the second objective lens 127 are attached to a common holder 131. The holder 131 is driven in both a focus direction and a tracking direction by an objective lens actuator 132. Accordingly, the first objective lens 108 and the second objective lens 127 are integrally driven in association with the drive of the holder 131. The first objective lens 108 and the second objective lens 127 are arranged in line in the disk radial direction. At this point, in the two objective lenses, the first objective lens 108 having the smaller lens diameter is arranged on an inner circumference side of the disk.

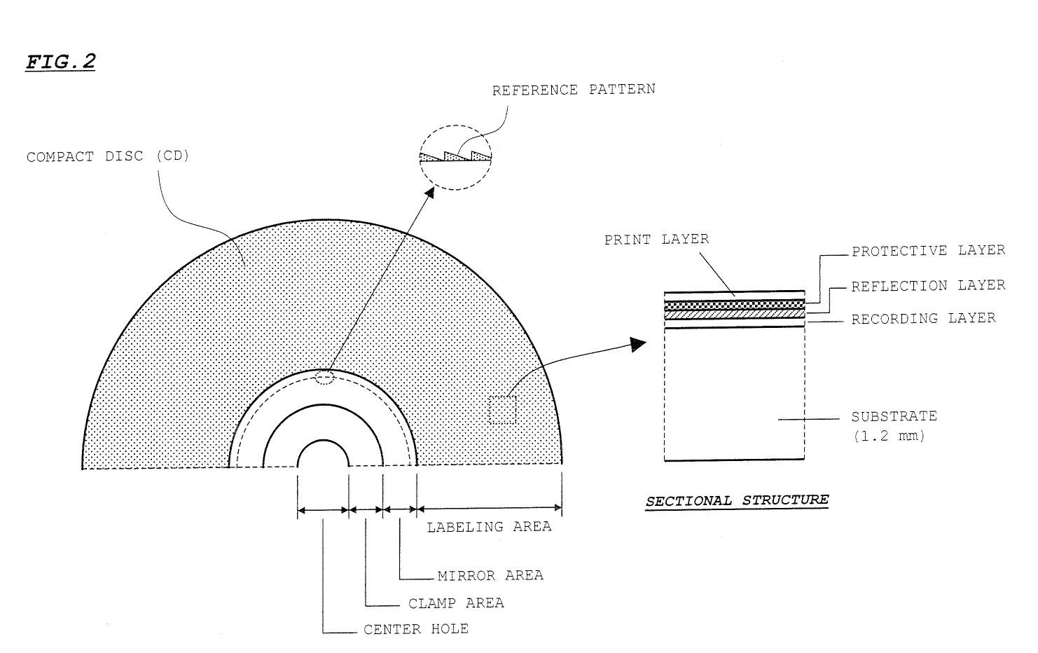

FIG. 2 shows an area format of a CD. FIG. 2 shows an area format of a CD surface to be printed, i.e., the surface opposite a signal recording surface. FIG. 2 also shows a CD sectional structure of a write-once type CD.

The CD surface to be printed is divided into a clamp area, a mirror area, and a labeling area from a center hole toward an outer circumference. A desired image of a user is labeled in the labeling area. As shown in the right side of FIG. 2, the sectional structure of the labeling area has a structure in which a recording layer, a reflection layer, a protective layer, and a print layer are sequentially laminated on the substrate having the thickness of 1.2 mm. The recording layer is made of an organic coloring material layer having the thickness of about 0.15 μm. The aluminum reflection layer having the thickness of about 0.1 mm is formed the recording layer by sputtering. The UV protective layer having the thickness of tens micrometers is formed on the reflection layer by spin coating and ultraviolet curing. The print layer is formed on the protective layer.

The mirror area has a structure in which the print layer is neglected in the sectional structure of FIG. 2. In the mirror area, one track is formed at a position slightly inside the innermost circumference position of the labeling area in order to be checked in performing the labeling. A sawtooth reference pattern and a rectangular information pattern are alternately arranged in the track. The patterns are formed by controlling a process of sputtering-forming the reflection layer. That is, the reflection layer is formed by controlling formation/non-formation in the sawtooth and rectangular shapes.

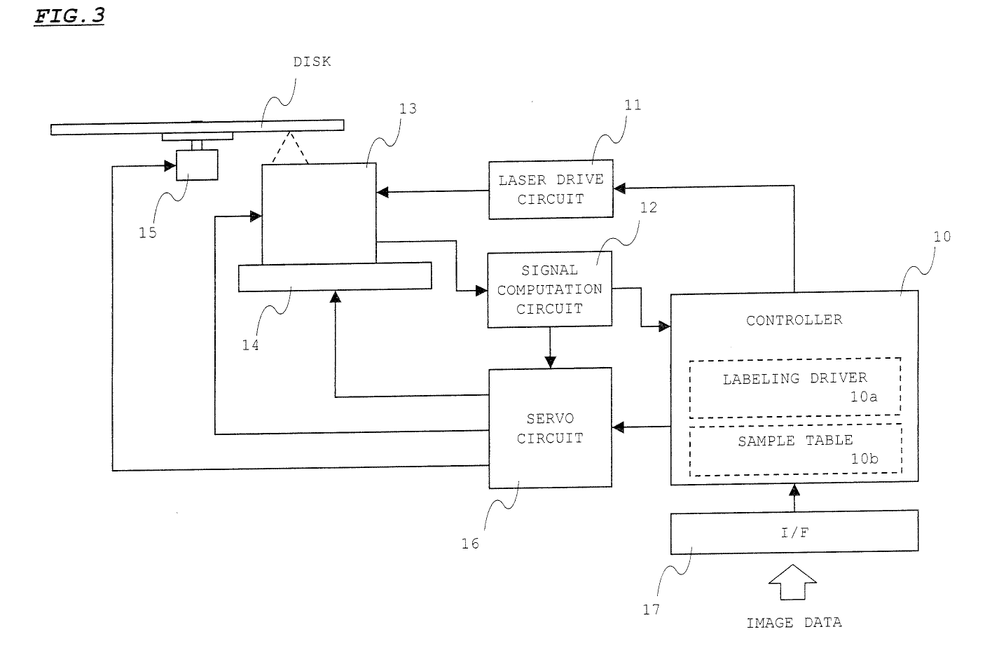

FIG. 3 shows a configuration of an optical disk apparatus of this example. In FIG. 3, only the configuration associated with the labeling is illustrated in the optical disk apparatus, and the configuration associated with the recording/reproduction operation is neglected.

Referring to FIG. 3, the optical disk apparatus includes a controller 10, a laser drive circuit 11, a signal computation circuit 12, an optical pickup 13, a pickup feed mechanism 14, a spindle motor 15, a servo circuit 16, and an interface (I/F) 17.

The controller 10 controls each unit according to a predetermined control routine. The controller 10 stores a labeling driver 10a and a sample table 10b in an internal memory. The labeling driver 10a regulates a labeling operation to CD. In the labeling operation, a radial position obtained based on the reference pattern and a current applied to the objective lens actuator 132 are stored as sample data in the sample table 10b.

The laser drive circuit 11 drives the semiconductor lasers 101 and 121 in the optical pickup 13 according to a control signal from the controller 10. The signal computation circuit 12 performs computation to the signals from the photodetectors 110 and 129 arranged in the optical pickup 13, and the signal computation circuit 12 generates the reproduction RF signal, a focus error signal, a tracking error signal, and a reflection light quantity signal. The signal computation circuit 12 outputs the focus error signal and the tracking error signal to the servo circuit 16, and the signal computation circuit 12 outputs the reflection light quantity signal to the controller 10. The signal computation circuit 12 outputs the reproduction RF signal to the servo circuit 16 and a reproduction processing circuit (not shown).

The optical pickup 13 includes the optical system shown in FIG. 1. The pickup feed mechanism 14 drives the optical pickup 13 in a disk radial direction according to the control signal from the servo circuit 16. The spindle motor 15 rotates the disk according to the control signal from the servo circuit 16.

The servo circuit 16 generates a focus servo signal and a tracking servo signal from the focus error signal and tracking error signal which are inputted from the signal computation circuit 12, and the servo circuit 16 outputs the focus servo signal and the tracking servo signal to the objective lens actuator 132 of the optical pickup 13. During the aberration correction, the servo circuit 16 outputs a drive signal to the lens actuator 105 of the optical pickup 13 while referring to the reproduction RF signal. The servo circuit 16 generates a rotation servo signal from a synchronous signal inputted from the signal computation circuit 12, and the servo circuit 16 outputs the rotation servo signal to the spindle motor 15. Additionally, the servo circuit 16 outputs the drive signal to the lens actuator 105 of the optical pickup 13, the objective lens actuator 132, the pickup feed mechanism 14, and the spindle motor 15 according to the control signal from the controller 10.

I/F 17 outputs the image data inputted from the outside to the controller 10.

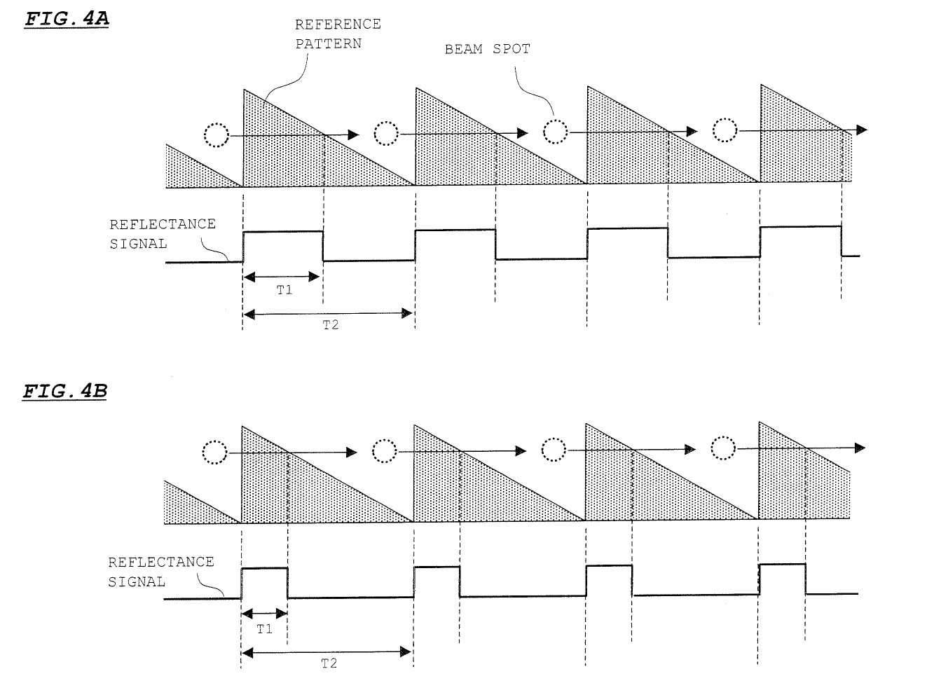

The process performed by the controller 10 in scanning the CD reference pattern with a beam spot will be described below with reference to FIGS. 4A and 4B. FIGS. 4A and 4B differ from each other in a scanning position of the beam spot.

Referring to FIGS. 4A and 4B, when the beam spot enters a formation area from a non-formation area of the reference pattern, a reflection light quantity from CD is changed to change the reflection light quantity signal which is inputted from the signal computation circuit 12 to the controller 10. In CD, because the reflection layer is not formed in the non-formation area of the reference pattern, a reflectance in the non-formation area of the beam spot is smaller than that of the formation area. Therefore, amplitude of the reflection light quantity signal inputted from the signal computation circuit 12 to the controller 10 is decreased as the beam spot enters the formation area from the non-formation area of the reference pattern.

The controller 10 generates a reflectance signal shown in FIGS. 4A and 4B based on the reflection light quantity signal changed in the above manner. The controller 10 also computes a beam spot scanning position in the disk radial direction from the duty cycle of the generated reflectance signal. At this point, because a height H0 of the reference pattern in the disk radial direction is previously determined, the height H0 is proportionally divided by T1 and T2 of FIGS. 4A and 4B, which determines the radial direction scanning position of the beam spot for a boundary position on the disk inner circumference side of the reference pattern.

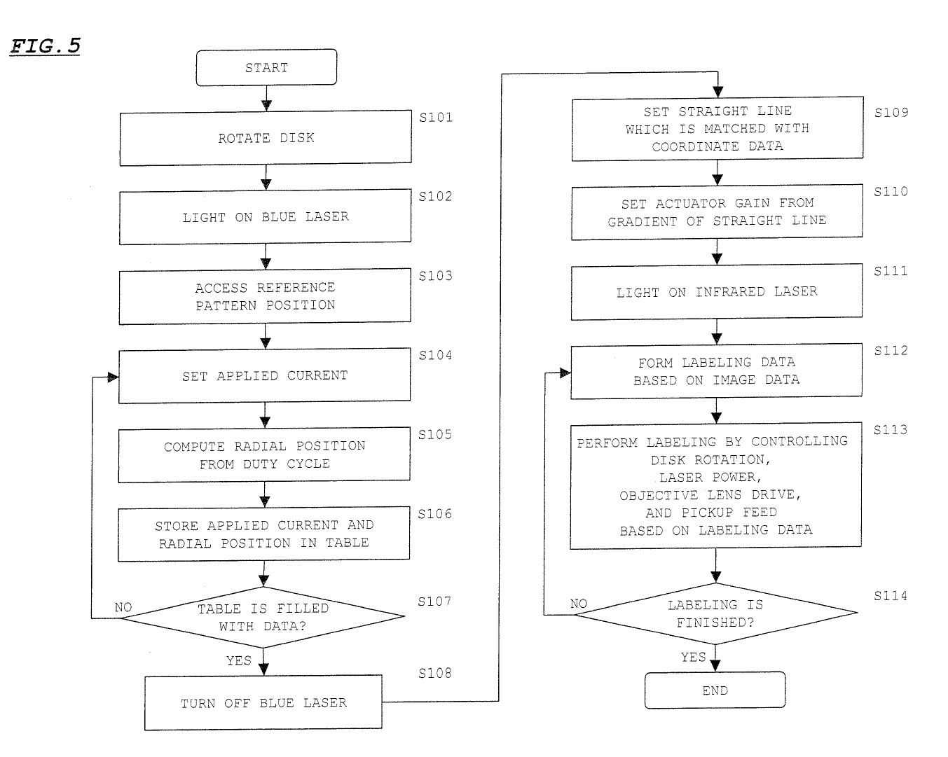

A labeling operation to CD will be described below with reference to FIG. 5.

In the labeling operation, CD is loaded on the optical disk apparatus while the right surface in the recording/reproduction is reversed. When a user inputs a labeling operation instruction after the CD is loaded this way, the disk is rotated at a predetermined speed (S101). The blue laser (semiconductor laser 101) is lit on (S102), and the pickup drive mechanism 14 is driven such that the beam spot accesses a neutral position (center position in the radial direction) of the reference pattern (S103).

Then, a current signal Dc is set to the objective lens actuator 132 of the optical pickup 13 (S104). The current signal Dc is set to drive the first objective lens 108 in the disk radial direction. The current signal Dc is set to zero immediately after the beam spot accesses the neutral position of the reference pattern.

As shown in FIGS. 4A and 4B, a beam spot scanning position Rp is obtained in the disk radial direction (S105). The obtained scanning position Pp and the current signal Dc set in S104 are stored as the sample data in the sample table 10b of the controller 10 (S106).

Then, the controller determines whether or not the sample table 10b is filled with the sample data (S107). When the sample table 10b is not filled with the sample data, the flow returns to Step S104, and the current signal Dc is set again. Therefore, the beam spot is displaced in the disk radial direction within a range of the reference pattern formation area. Then, the beam spot scanning position Rp is obtained again (S105). The obtained scanning position Rp and the current signal Dc are stored as the sample data in the sample table 10b of the controller 10 (S106).

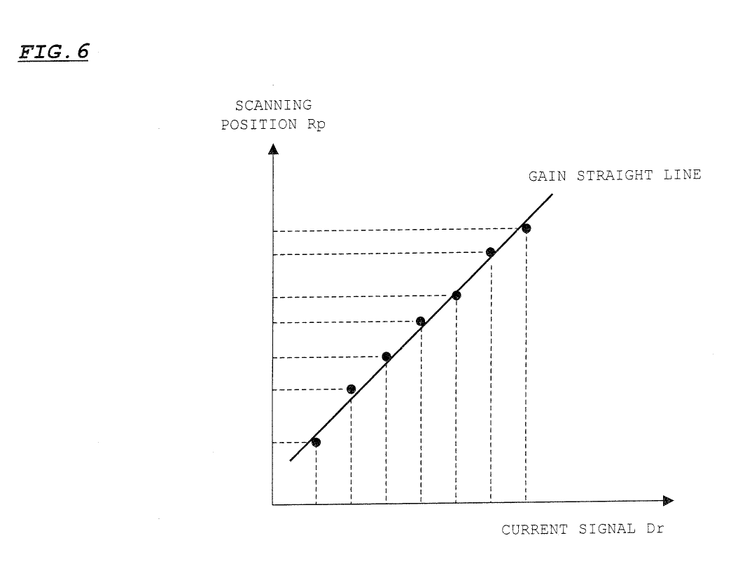

The sample data storing process is repeated until the sample table 10b is filled with the sample data. When sample table 10b is filled with the sample table 10b (YES in Step S107), the blue laser beam is turned off (S108). A straight line (gain straight line) which is best matched with the sample data is applied as shown in FIG. 6, (S109). A gain is determined based on a gradient of the gain straight line when the objective lens actuator 132 is driven in the disk radial direction (S110).

Then, the infrared laser is lit on (S111), and labeling data for writing the image in the CD labeling area is generated based on image data inputted through I/F 17 (S112). Assuming that one track is one turn of the disk, the labeling data is one which regulates light emission timing of the infrared laser beam on the track. The labeling data is generated for each track from the innermost circumference to the outermost circumference of the labeling area. A degree of fineness of the print image is determined by a track pitch.

Then, disk rotation control, laser power control, and objective lens drive control and pickup feed control in the disk radial direction are performed such that the image portion is printed based on the labeling data corresponding to the track (S113). The objective lens drive control is performed based on the gain obtained in S110.

The image printing process is repeated until completed for all the tracks set in the labeling area (S114). When the image printing process is completed for all the tracks (YES in Step S114), the labeling operation is ended.

According to this example, in the two objective lenses, the first objective lens having the smaller diameter is arranged on the inner circumference side of the disk, so that a clearance can be increased between the inner circumference-side objective lens and the turntable compared with the case in which the second objective lens is arranged on the inner circumference side. Because the reference pattern is irradiated with the laser beam through the first objective lens located on the inner circumference side of the disk in obtaining the gain, it is not necessary that the first objective lens drive position be located inside the reference pattern position. Therefore, the clearance can be ensured between the first objective lens and the turntable. Because the gain obtained in the above manner is directly used as the gain of the second objective lens, the smooth labeling operation can be realized by irradiating the disk with the laser beam from the second objective lens to perform the image labeling.

In this example, the labeling is performed not with the blue laser beam but with the infrared laser beam. This is because that the labeling target is CD and output power of the semiconductor laser emitting the laser beam having the infrared wavelength is much lager than that of the semiconductor laser emitting the laser beam having the blue wavelength.

In this example, the CD surface is irradiated with the blue laser beam to read the reference pattern. Even in the irradiation with the blue laser beam, the reference pattern can be irradiated with the beam spot having the size enough to read the reference pattern.

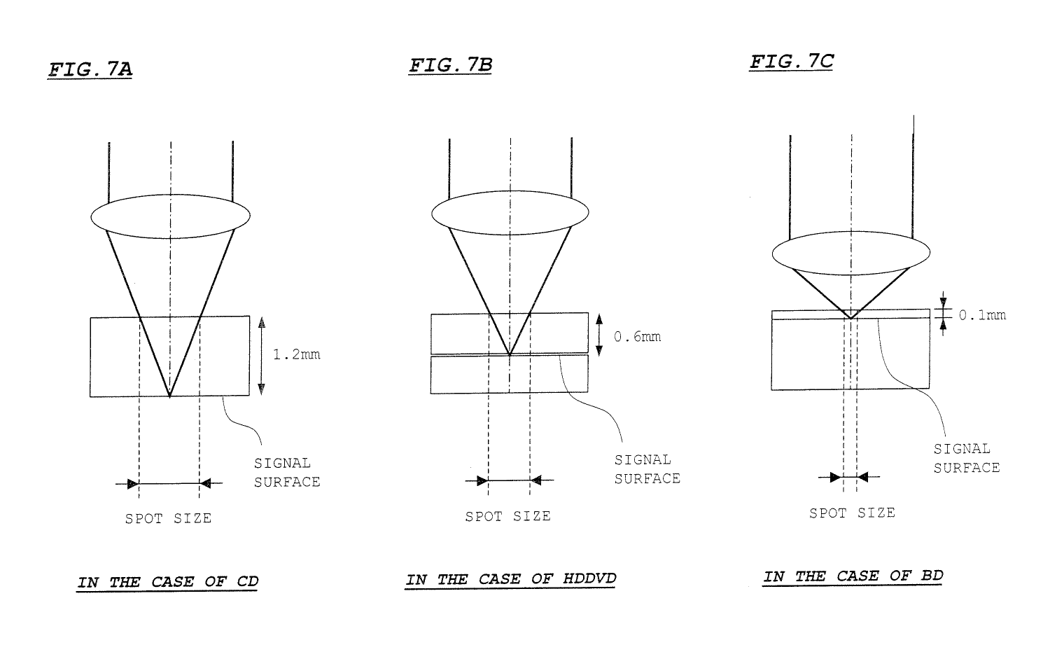

FIG. 7A shows a state in which the infrared laser beam is converged onto the signal surface of CD using the CD objective lens, FIG. 7B shows a state in which the blue laser beam is converged onto the signal surface of HDDVD using the HDDVD objective lens, and FIG. 7C shows a state in which the blue laser beam is converged onto the signal surface of the Blu-ray disk (BD) using the BD objective lens.

As shown in FIG. 7, the laser beam of FIG. 7A has the largest spot size on the disk surface on the objective lens side, and the laser beam of FIG. 7C has the smallest spot size. Accordingly, even if the first objective lens 108 is either the HDDVD objective lens or the BD objective lens, the spot size in the irradiation of CD with the blue laser beam through the first objective lens 108 is smaller than that in the irradiation of CD with the infrared laser beam through the CD objective lens in the surface on the objective lens side. Therefore, in this example, even if the CD surface is irradiated with the blue laser beam to read the reference pattern, the reference pattern can be irradiated with the beam spot having the sufficiently small size.

### SECOND EXAMPLE

In this example, the invention is applied to an optical disk apparatus in which the recording and reproduction are performed to the next-generation DVD, DVD, and CD.

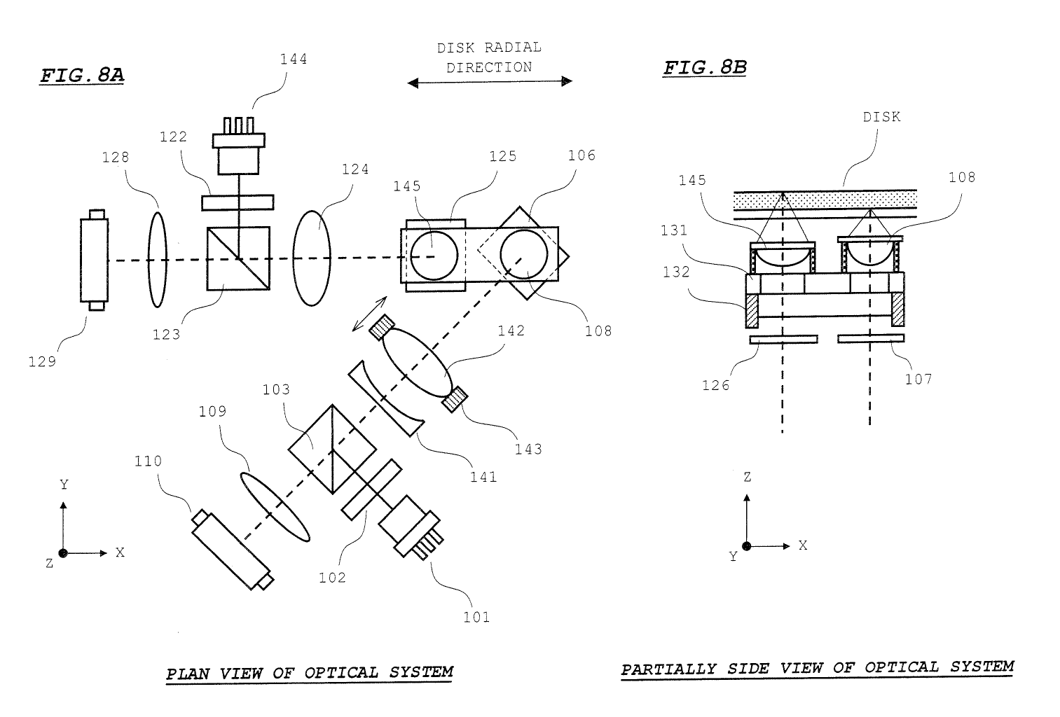

FIGS. 8A and 8B show an optical system of an optical pickup according to this example. FIG. 8A is a plan view of the optical system and FIG. 8B is a side view showing a neighborhood of an objective lens actuator. The optical system is divided into a next-generation DVD optical system and a CD/DVD optical system.

The CD/DVD optical system includes the diffraction grating 122, the polarization beam splitter 123, the collimator lens 124, the rising mirror 125, the anamorphic lens 128, and the photodetector 129, a semiconductor laser 144, and a second objective lens 145. The semiconductor laser 144 emits the laser beam having the infrared wavelength of about 780 nm and the laser beam having the red wavelength of about 650 nm. The second objective lens 145 converges the laser beam having the infrared wavelength and the laser beam having the red wavelength onto the corresponding disks. Due to a difference in substrate thickness between CD and DVD, it is necessary to restrict a numerical aperture of the second objective lens 145 for the laser beam having the infrared wavelength. For this reason, a film is formed in the surface on the laser beam incident side of the second objective lens 145 in order to restrict the numerical aperture of the second objective lens 145 for the infrared laser beam.

In the optical elements of the CD/DVD optical system, the same optical element as the optical system of FIGS. 1A and 1B is designated by the same numeral. However, in the optical elements, optical design and the like are appropriately adjusted such that the function compatible with both the infrared laser beam and the red laser beam can be imparted.

The next-generation DVD optical system includes the semiconductor laser 101, the diffraction grating 102, the polarization beam splitter 103, the rising mirror 106, the first objective lens 108, the anamorphic lens 109, and the photodetector 110, a concave lens 141, a convex lens 142, and a lens actuator 143. In the optical elements of the next-generation DVD optical system, the same optical element as the optical system of FIGS. 1A and 1B is designated by the same numeral. In this example, a beam expander including the concave lens 141 and the convex lens 142 is formed in place of the collimator 104 of the first example. The convex lens 142 is driven in the optical axis direction of the laser beam by the lens actuator 143.

During the usual recording and reproduction, the convex lens 143 is located at the position where the laser beam traveling to the reflecting mirror 106 becomes the parallel light, and the convex lens 143 is displaced in the optical axis direction of the laser beam in order to correct the aberration. As with the first example, the convex lens 143 is controlled during the aberration correction by the servo circuit 16.

In this example, it is assumed that the labeling is performed to DVD in addition to CD. As with CD, in DVD, the reference pattern is formed at the inner circumference position of the disk. However, because DVD is formed by bonding the two substrates, the DVD reference pattern is arranged at the back of the substrate having the thickness of 0.6 mm unlike CD. Therefore, in reading the DVD reference pattern, it is necessary that the beam spot of the blue laser beam be located at the position deeper than that of CD by 0.6 mm.

In the case where the first objective lens 108 is the HDDVD objective lens, because the HDDVD objective lens originally converges the beam spot on the signal surface located at the back of the substrate having the thickness of 0.6 mm as shown in FIG. 7B, the HDDVD objective lens can converge the beam spot having the trouble-free size on the reference pattern even if the DVD reference pattern is arranged at the back of the substrate having the thickness of 0.6 mm.

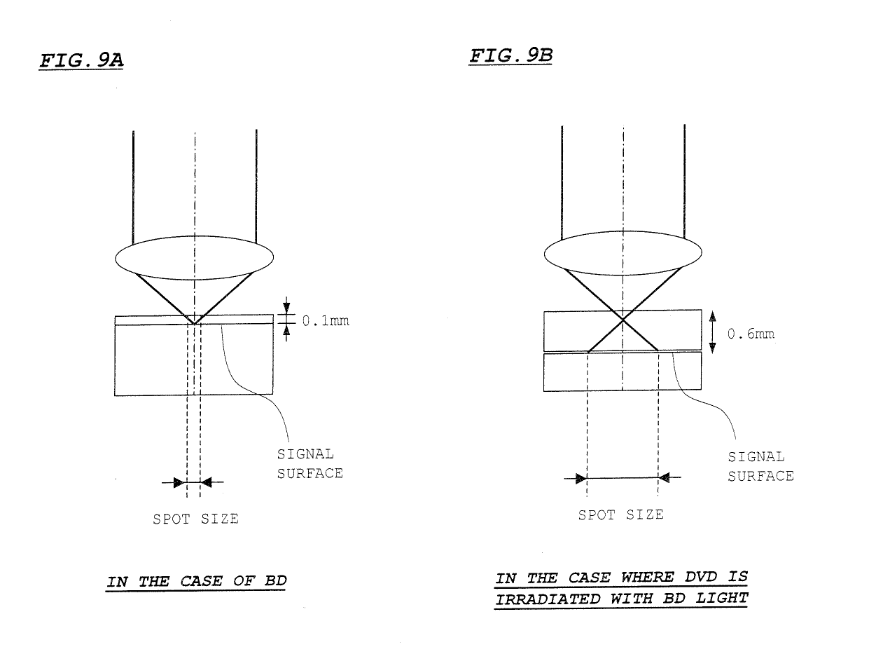

On the other hand, in the case where the first objective lens 108 is the BD objective lens, the beam spot size is considerably increased on the reference pattern located at the back of the substrate having the thickness of 0.6 mm as shown in FIG. 9B when DVD is irradiated with the blue laser beam. Therefore, possibly the reference pattern is not read well. In such cases, the spot size is decreased on the reference pattern by displacing the first objective lens 108 toward the disk surface side. However, because the BD objective lens has the high numerical aperture and the considerably small working distance, the BD objective lens collides possibly with the disk surface when the BD objective lens is brought close to the disk. Accordingly, the configuration for locating the beam spot of the blue laser beam on the DVD reference pattern is required in the case where the first objective lens 108 is the BD objective lens.

In this example, the beam spot is located on the DVD reference pattern by controlling the position of the convex lens 143.

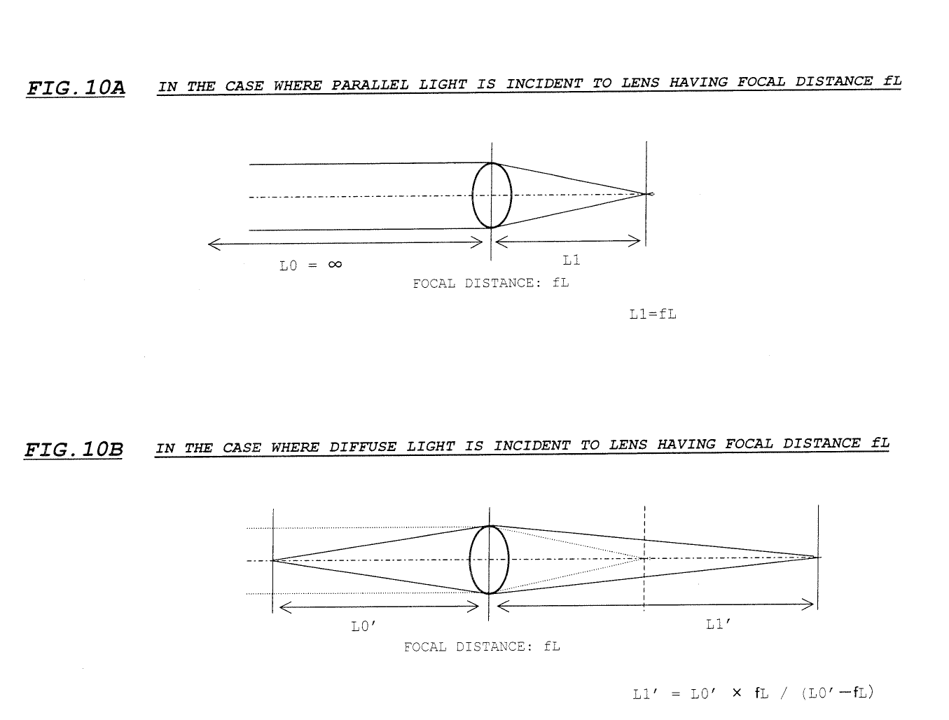

The method of locating the beam spot of the blue laser beam on the DVD reference pattern will be described with reference to FIGS. 10A and 10B.

A difference in substrate thickness between DVD and BD is 0.5 mm as shown in FIGS. 9A and 9B. Because a refractive index of the substrate is about 1.6, in order to locate the beam spot of the blue laser beam on the DVD reference pattern, it is necessary that a focal distance be extended by 0.5/1.6-0.32 mm. For example, assuming that φ=3 mm is an effective diameter of the first objective lens 108 and NA=0.85 is a numerical aperture, a focal distance f of the first objective lens 108 becomes f=1.765 mm from φ=2×NA×f.

When the diffuse light is incident to the first objective lens 108 to extend the focal distance by 0.32 mm, the focal distance becomes 1.765+0.32=2.085 mm. In this case, the numerical aperture becomes NA=3/2/2.085=0.72.

In order that the diffuse light is incident to the first objective lens 108 to obtain NA=0.72, it is necessary that the focal distance be set to f=2.085 mm. Therefore, in FIG. 10B, it is necessary that L0′ be determined so as to obtain L1′=2.085. In this case, L0′=11.5 mm is obtained from 2.085=L0′×1.765/(L0′−1.765). Accordingly, it is necessary that the diffuse light be generated be moving the convex lens 143 (the convex lens 143 is brought close toward the side of the semiconductor laser 101) such that the blue laser beam incident to the first objective lens 108 becomes the focal distance of 11.5 mm. This enables the focal distance to be extended by 0.5 mm in the DVD substrate to locate the small-size beam spot on the reference pattern.

Because the spot size (spot diameter) is proportional to λ/NA, assuming that the second objective lens 142 has the numerical aperture of 0.65 for the red laser beam, the spot size of the blue laser beam becomes 405/0.72<650/0.65. That is, the beam spot of which the reference pattern is irradiated with blue laser beam through the first objective lens 108 becomes smaller than the beam spot of which the reference pattern is irradiated with red laser beam through the second objective lens 142 by a factor of 0.56. Therefore, when the convex lens 143 is driven to irradiate DVD with the blue laser beam, the sufficiently small beam spot can be located on the reference pattern to smoothly read the reference pattern on DVD.

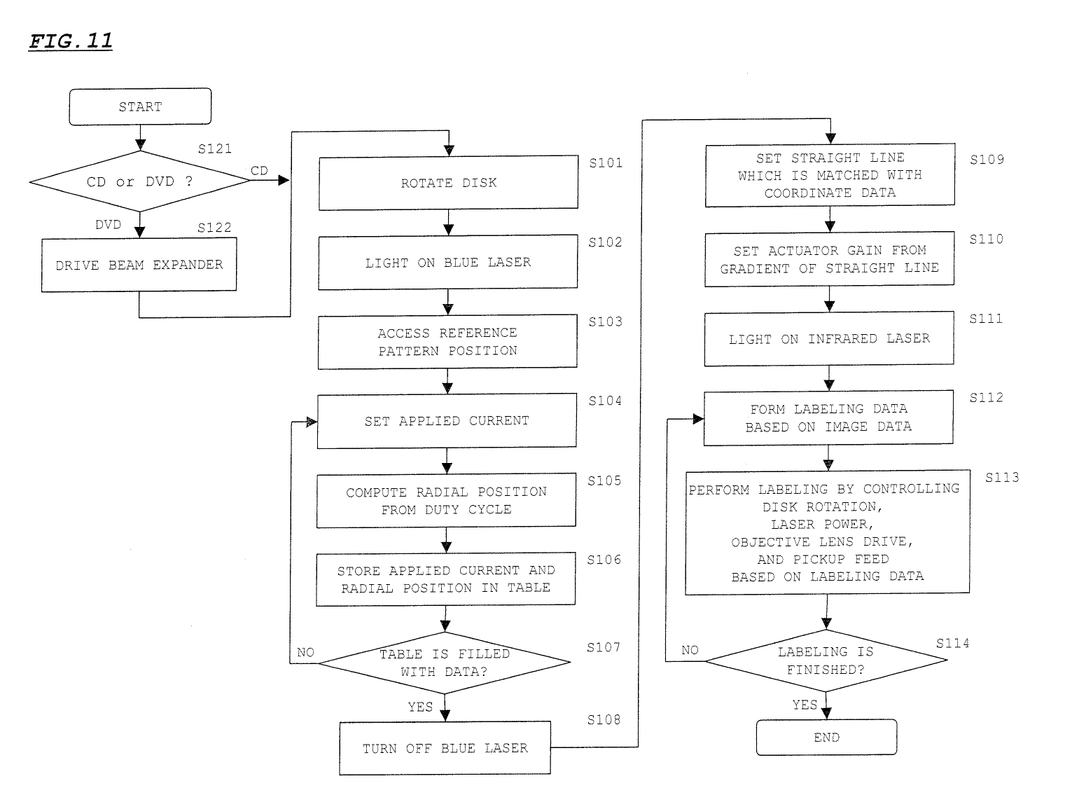

FIG. 11 shows a flowchart in performing the labeling operation to CD and DVD. The flowchart shown in FIG. 11 is used in the case where the BD objective lens is used as the first objective lens 108. In the case where the HDDVD objective lens is used as the first objective lens 108, as described above with reference to FIG. 7B, the blue laser beam spot having the sufficiently small size is located on the DVD reference pattern, so that the labeling operation can also be performed to DVD in addition to CD according to the flowchart of FIG. 5.

When compared with the flowchart of FIG. 5, Steps S121 and S122 are added in the flowchart of FIG. 11. In the flowchart of FIG. 11, other steps are similar to those of FIG. 5. At the beginning of the flowchart, the beam expander is initialized to optimize the reading to CD.

In the flowchart, when the labeling operation is started, the controller 10 determines whether the loaded disk is CD or DVD (S121). The controller 10 distinguishes between CD and DVD based on instruction input from a user. The instruction input indicates which the labeling target is CD or DVD.

In Step S121, when the controller 10 determines that the loaded disk is CD, the flow goes to Step S101, and the same process as that of FIG. 5 is performed. In Step S121, when the controller 10 determines that the loaded disk is DVD, the convex lens 143 constituting the beam expander is driven to the position where the diffuse light described with reference to FIG. 10B is incident to the first objective lens 108. Therefore, the beam spot of the blue laser beam is located on the reference pattern. Then, the flow goes to Step S101, and the same process as that of FIG. 5 is performed.

As with FIG. 5, printing the image on DVD is performed using the infrared laser beam (S111). Alternatively, printing the image on DVD may be performed using the red laser beam.

In this example, the laser beam diffusion state is changed by the beam expander including the concave lens 141 and the convex lens 143. Alternatively, as with FIGS. 1A and 1B, the collimator lens 104 and the actuator 105 are arranged, the collimator lens 104 is driven in the optical axis direction, and thereby the laser beam diffusion state may be changed.

According to this example, as with the first example, the clearance can properly be ensured between the first objective lens and the turntable. The labeling can smoothly be performed to both CD and DVD while the disk is irradiated with the laser beam through the second objective lens.

The invention is not limited to the above examples. Various changes and modifications can be made regarding the embodiments of the invention without departing from the scope and spirit of the invention.

What is claimed is:

1. An optical disk apparatus comprising:
a first light source which emits a laser beam having a first wavelength;
a second light source which emits a laser beam having a second wavelength;
a first objective lens which converges the laser beam having the first wavelength;
a second objective lens which converges the laser beam having the second wavelength;
a holder which integrally holds the first objective lens and the second objective lens;
an objective lens actuator which drives the holder;
a pickup actuator which drives an optical pickup in a disk radial direction, the optical pickup including the first light source, the second light source, the first objective lens, the second objective lens, the holder, and the objective lens actuator;
a spindle motor which rotates a disk; and
an image generation circuit which generates an image in a disk surface by driving and controlling the first light source, the second light source, the objective lens actuator, the pickup actuator, and the spindle motor,
wherein the first objective lens and the second objective lens are arranged in line on a disk diameter, the first objective lens is arranged on a disk inner circumference side of the second objective lens,
the image generation circuit irradiates a reference pattern with the laser beam having the first wavelength while rotating the disk which is of an image generation target, the reference pattern being formed at an inner circumference position of the disk, the image generation circuit obtains a gain when the objective lens actuator is driven in the disk radial direction, and the image generation circuit irradiates the disk of the image generation target with the laser beam having the second wavelength to generate the image in the disk surface while driving the objective lens actuator with the obtained gain.

2. The optical disk apparatus according to claim 1, wherein the first objective lens has a lens diameter smaller than a lens diameter of the second objective lens.

3. The optical disk apparatus according to claim 1 or 2, wherein the optical pickup includes an optical element which shifts a focal position of the laser beam having the first wavelength to an optical axis direction of the laser beam, and
the image generation circuit drives the optical element to shift the focal position of the laser beam having the first wavelength to a direction in which the focal position is separated away from the first objective lens by a predetermined distance, when the gain is obtained.

4. The optical disk apparatus according to claim 3, wherein the optical element changes a degree of diffusion of the laser beam incident to the first objective lens.

5. The optical disk apparatus according to claim 4, wherein the optical element includes a lens and a lens actuator, the lens converting the laser beam having the first wavelength into parallel light, the laser beam having the first wavelength being emitted from the first light source, the lens actuator driving the lens in the optical axis direction of the laser beam.

6. The optical disk apparatus according to claim 5, wherein the lens is driven in the optical axis direction of the laser beam having the first wavelength to correct aberration generated in the laser beam having the first wavelength in recording and/or reproduction of the disk.

7. The optical disk apparatus according to claim 1 or 2, wherein the first light source emits laser beam for a next-generation Digital Versatile Disk, and
the second light source emits a laser beam for a Compact Disk.

8. The optical disk apparatus according to claim 3, wherein the first light source emits a laser beam for a next-generation Digital Versatile Disk,
the second light source emits a laser beam for a Compact Disk and a Digital Versatile Disk laser beam, and
the image generation circuit drives the optical element to shift the focal position of the next-generation DVD laser beam to a direction in which the focal position is separated away from the first objective lens by a predetermined distance, when the image is generated in DVD.

9. The optical disk apparatus according to claim 8, wherein the image generation circuit generates the image in the disk surface by irradiating the disk of the image generation target with one of the CD laser beam and the DVD laser beam.
